(19) United States
(12) Patent Application Publication
(10) Pub. No.: US 2025/0162159 A1
(43) Pub. Date: May 22, 2025

(54) ALIGNING A ROBOTIC ARM TO AN OBJECT

(71) Applicant: Universal Robots A/S, Odense S (DK)

(72) Inventors: Chu-Yin CHANG, South Hamilton, MA (US); Bruce BLUMBERG, Concord, MA (US); David Demirdjian, Boca Raton, FL (US); Andrew PETHER, Cambridge, MA (US); Ralph F. POLIMENI, JR., Reno, NV (US); Daniel SMITHWICK, Somerville, MA (US)

(73) Assignee: Universal Robots A/S, Odense S (DK)

(21) Appl. No.: 18/511,950

(22) Filed: Nov. 16, 2023

(51) Int. Cl. B25J 9/16

(52) U.S. Cl. CPC B25J 9/1697; B25J 9/1628

(57) ABSTRACT

An example robotic system includes a robotic arm configured to move in multiple degrees of freedom and a control system including one or more processing devices. The one or more processing devices are programmed to perform operations including: identifying an object in the environment accessible to the robotic arm based on sensor data indicative of the environment; determining that a component associated with the robotic arm is within a predefined distance of the object; and controlling the robotic arm to move the component toward or into alignment with the object in response to the component being within the predefined distance of the object.

### TECHNICAL FIELD

This specification describes examples of systems and processes for aligning a robotic arm to an object.

### BACKGROUND

A robot, such as a robotic arm, is configured to control an end effector to interact with the environment. An example end effector is an accessory or tool that the robot uses to perform an operation.

An example robotic arm is a computer-controlled robot that is capable of moving in multiple degrees of freedom. The robotic arm may be supported by a base and may include one or more links interconnected by joints. The joints may be configured to support rotational motion and/or translational displacement relative to the base. A tool flange may be on the opposite end of the robotic arm from the base. The tool flange contains an end effector interface. The end effector interface enables an accessory to connect to the robotic arm. In an example operation, the joints are controlled to position the robotic arm to enable the accessory to implement a predefined operation. For instance, if the accessory is a welding tool, the joints may be controlled to position, and thereafter to reposition, the robotic arm so that the welding tool is at successive locations where welding is to be performed on a workpiece.

### SUMMARY

An example robotic system includes a robotic arm configured to move in multiple degrees of freedom and a control system including one or more processing devices. The one or more processing devices are programmed to perform operations including: identifying an object in an environment accessible to the robotic arm based on sensor data indicative of the environment; determining that a component associated with the robotic arm is within a predefined distance of the object; and controlling the robotic arm to move the component toward or into alignment with the object in response to the component being within the predefined distance of the object. The example robot system may include one or more of the following features, either alone or in combination.

Determining that the component associated with the robotic arm is within the predefined distance of the object may include determining that the component of the robotic arm is within a first distance from the object (e.g., a predefined vicinity of the object). Controlling the robotic arm to move the component toward alignment with the object may be performed in response to the component of the robotic arm being within the first distance from the object. Determining that the component associated with the robotic arm is within the predefined distance of the object may include determining that the component of the robotic arm is within a second distance from the object (e.g., a predefined threshold distance). The second distance may be less than the first distance. Controlling the robotic arm to move the component into alignment with the object may be performed in response to the component of the robotic arm being within the second distance from the object and with greater force than moving the component toward alignment.

Identifying the object may include identifying an axis of the object. The predefined distance may be measured relative to the axis of the object. Controlling the robotic arm to move the component into alignment may include controlling the robotic arm to move the component into alignment with the axis. The axis may be along a center of the object. The axis may be along a part of the object. The operations may include, following alignment of the component with the axis, constraining movement of at least part of the robotic arm to be along the axis. The operations may include, following alignment of the component with the axis, constraining movement of at least part of the robotic arm relative to the axis. The operations may include, following controlling the robotic arm to move the component into alignment with the object, enabling manual movement of at least part of the robotic along the axis to allow the robotic arm to interact with the object; recording movements of the robotic arm interacting with the object; translating the movements into robot code; and storing the robot code in memory on the control system. The operations may include recording operational parameters of the robotic system; translating the operational parameters into robot code; and storing the robot code in memory on the control system. The operational parameters may relate to one or more of the following: input/output ports in the robotic system or an end effector or tool connected to the robotic arm.

The operations may include, prior to controlling the robotic arm to move the component into alignment, controlling the robotic arm to enable manual movement of the robotic arm in multiple degrees of freedom. Controlling the robotic arm to move the component into alignment may be performed automatically absent manual intervention. Controlling the robotic arm to move the component into alignment may be performed in combination with manual movement of the robotic arm.

The component may include a tool connected to the robotic arm. The component may include a part of the robotic arm.

The robotic system may include a vision system associated with the robotic arm to capture the sensor data. The vision system may include one or more cameras and/or other sensors mounted to the robotic arm. The operations may include receiving the sensor data electronically.

The operations may include enabling the robotic arm to be moved out of the predefined distance during alignment in response to a predetermined amount of manual force.

The environment may contain multiple objects. Each of the multiple objects may be a candidate for alignment with the component. Each of the multiple objects may be at a different distance from the component. The object to which the component is configured to align may be a closest one of the multiple objects to the component.

An example method of controlling a robotic arm includes obtaining sensor data indicative of an environment accessible to the robotic arm; identifying an object in the environment based on the sensor data; determining that a component associated with the robotic arm is within a predefined distance of the object; and controlling the robotic arm to move the component toward or into alignment with the object in response to the component being within the predefined distance of the object. The example method may include one or more of the following features, either alone or in combination.

Determining that the component associated with the robotic arm is within the predefined distance of the object may include determining that the component of the robotic arm is within a first distance from the object (e.g., a predefined vicinity of the object). Controlling the robotic arm to move the component toward alignment with the object may be performed in response to the component of the robotic arm being within the first distance from the object. Determining that the component associated with the robotic arm is within the predefined distance of the object may include determining that the component of the robotic arm is within a second distance from the object (e.g., a predefined threshold distance). The second distance may be less than the first distance. Controlling the robotic arm to move the component into alignment with the object may be performed in response to the component of the robotic arm being within the second distance from the object and with greater force than moving the component toward alignment.

Identifying the object may include identifying an axis of the object. The predefined distance may be measured relative to the axis of the object. Controlling the robotic arm to move the component into alignment may include controlling the robotic arm to move the component into alignment with the axis. The axis may be along a center of the object. The axis may be along a part of the object.

The method may include, following alignment of the component with the axis, constraining movement of at least part of the robotic arm to be along the axis. The method may include, following alignment of the component with the axis; constraining movement of at least part of the robotic arm relative to the axis. The method may include, following controlling the robotic arm to move the component into alignment with the object; enabling manual movement of at least part of the robotic arm along the axis to allow the robotic arm to interact with the object; recording movements of the robotic arm interacting with the object; translating the movements into robot code; and storing the robot code in memory on the control system. The method may include, recording operational parameters of the robotic system; translating the operational parameters into robot code; and storing the robot code in memory on the control system. The operational parameters may relate to one or more of the following: input/output ports in the robotic system, or an end effector or tool connected to the robotic arm.

The method may include, prior to controlling the robotic arm to move the component into alignment, controlling the robotic arm to enable manual movement of the robotic arm in multiple degrees of freedom. Controlling the robotic arm to move the component into alignment may be performed automatically absent manual intervention. Controlling the robotic arm to move the component into alignment may be performed in combination with manual movement of the robotic arm.

The component may include a tool connected to the robotic arm. The component may include a part of the robotic arm.

The sensor data may be obtained electronically. The sensor data may be obtained from a vision system, such as one or more cameras, connected to the robotic arm.

The method may include enabling the robotic arm to be moved out of the predefined distance during alignment in response to a predetermined amount of manual force.

The environment may contain multiple objects. Each of the multiple objects may be a candidate for alignment with the component. Each of the multiple objects may be at a different distance from the component. The object to which the component is configured to align may be a closest one of the multiple objects to the component.

In an example, one or more non-transitory machine-readable storage devices store instructions that are executable by one or more processing devices to control a robotic arm. The instructions are executable to perform example operations that include: obtaining sensor data indicative of an environment accessible to the robotic arm; identifying an object in the environment based on the sensor data; determining that a component associated with the robotic arm is within a predefined distance of the object; and controlling the robotic arm to move the component toward or into alignment with the object in response to the component being within the predefined distance of the object.

As used herein, the terms “comprises,” “comprising,” “includes,” “including,” “has,” “having,” “contains,” “containing,” and any variations thereof, are intended to cover a non-exclusive inclusion, such that robots, systems, techniques, apparatus, structures, or other subject matter described or claimed herein that includes, has, or contains an element or list of elements does not include only those elements but can include other elements not expressly listed or inherent to such robots, systems, techniques, apparatus, structures, or other subject matter described or claimed herein.

Any two or more of the features described in this specification, including in this summary section, may be combined to form implementations not specifically described in this specification.

At least part of the robots, systems, techniques, apparatus, and/or structures described in this specification may be configured or controlled by executing, on one or more processing devices, machine-executable instructions that are stored on one or more non-transitory machine-readable storage media. Examples of non-transitory machine-readable storage media include read-only memory, an optical disk drive, memory disk drive, and random access memory. The robots, systems, techniques, apparatus, and/or structures described in this specification may be configured, for example, through design, construction, composition, arrangement, placement, programming, operation, activation, deactivation, and/or control.

The details of one or more implementations are set forth in the accompanying drawings and the following description. Other features and advantages will be apparent from the description and drawings, and from the claims.

### DESCRIPTION OF THE DRAWINGS

FIG. 1 is a perspective view of an example system containing an example robot, specifically a robotic arm.

FIG. 2 is a flowchart showing example operations included in an example process for aligning a component associated with a robotic arm to an object.

FIGS. 3, 4, 5, and 6 are block diagrams showing, graphically, operations performed for aligning a component associated with a robotic arm to an example cylindrical object.

FIG. 7 is a block diagram showing an example of another object to which a component associated with a robotic arm may be aligned.

FIGS. 8, 9, 10, and 11 are block diagrams showing, graphically, operations performed for aligning a component associated with a robotic arm to an example intersection of two surface.

FIGS. 12, 13, and 14 show examples of other objects to which a component associated with a robotic arm may be aligned.

FIG. 15 is a block diagram showing, graphically, operations performed for aligning a component associated with a robotic arm to one of multiple example cylindrical objects.

Like reference numerals in different figures indicate like elements

### DETAILED DESCRIPTION

Described herein are examples of systems and processes for aligning a component associated with a robotic arm to an object. The component associated with the robotic arm may be part of the robotic arm itself or an accessory or other device connected or attached to the robotic arm. Example implementations are described in the context of a robotic arm system; however, the systems and processes, and their variants described herein, are not limited to this context and may be used with appropriately movable components associated with of any type of robotic system.

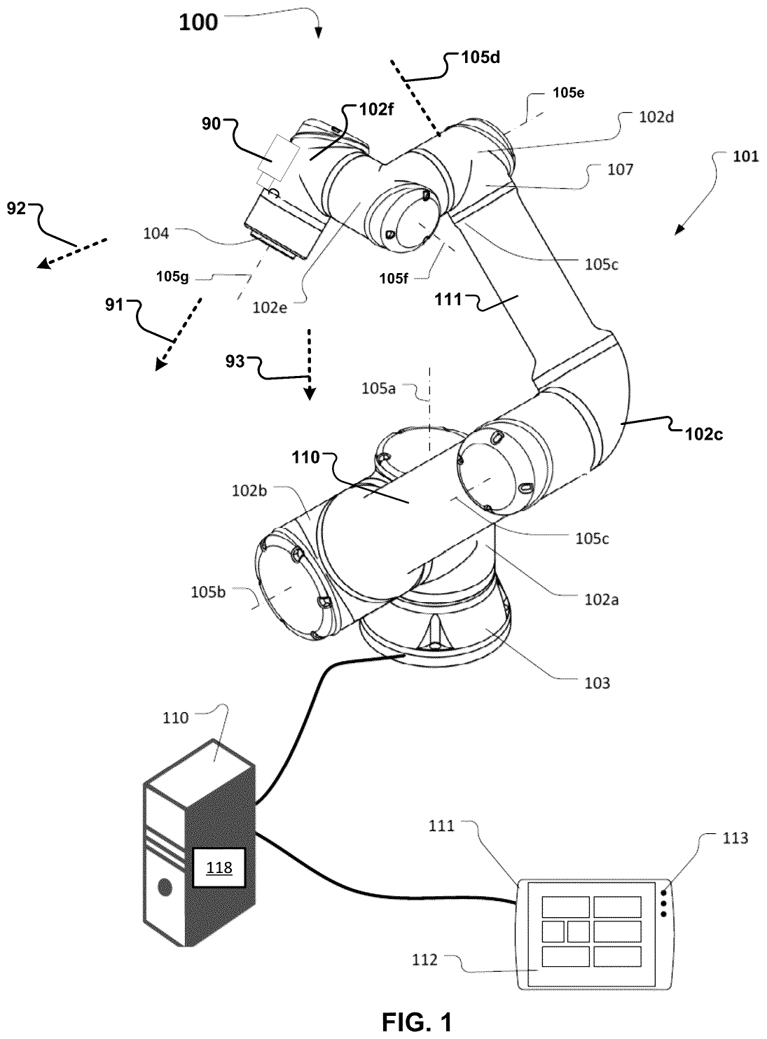

FIG. 1 show an example robotic system (“system”) 100 with which the systems and processes described herein may be implemented. System 100 includes robotic arm (“arm”) 101. Arm 101 includes robot joints (“joints”) 102a, 102b, 102c, 102d, 102e, and 102f connecting a robot base (“base”) 103 and a robot tool flange (“tool flange”) 104.

In this example, example arm 101 includes seven joints that are movable or rotatable; however, other implementations of arm 101 may include fewer than seven joints that are movable or rotatable or more than seven joints that are movable or rotatable. Arm 101 is thus a seven-axis robot arm having six degrees of freedom enabled by the seven joints. The joints in this example include the following: base joint 102a configured to rotate around axis 105a; shoulder joint 102b configured to rotate around axis 105b; elbow joint 102c configured to rotate around elbow axis 105c; first wrist joint 102d configured to rotate around first wrist axis 105d; and second wrist joint 102e configured to rotate around second wrist axis 105e. As noted, the joints in this example also include joint 102f. Joint 102f is a tool joint containing tool flange 104 and is configured to rotate around axis 105f. Tool flange 104 is joint that is configured to rotate around axis 105g. In some implementations one or more of the above-described axes of rotation can be omitted. For example, rotation around axis 105d can be omitted, making arm 101 a six-axis robot in this example.

Arm 101 also includes links 110 and 111. Link 110 is a cylindrical device that connects joint 102b to 102c. Link 111 is a cylindrical device that connects joint 102c to 102d. Other implementations may include more than, or fewer than, two links and/or links having non-cylindrical shapes.

In this example, tool flange 104 is on an opposite end of arm 101 from base 103; however, that need not be the case in all robots. Tool flange 104 contains an end effector interface. The end effector interface enables an end effector to connect to arm 101 mechanically and/or electrically. To this end, the end effector interface includes a configuration of mechanical and/or electrical contacts and/or connection points to which an end effector may mate and thereby attach to arm 101. An example end effector includes a tool or an accessory, such as those described below, configured to interact with the environment.

Examples of accessories—for example, end effectors—that may be connected to the tool flange via the end effector interface include, but are not limited to, mechanical grippers, vacuum grippers, magnetic grippers, screwing machines, reverse screwing machines, welding equipment, gluing equipment, liquid or solid dispensing systems, painting equipment, visual systems, cameras, scanners, wire holders, tubing holders, belt feeders, polishing equipment, laser-based tools, and/or others not listed here. Arm 101 includes one or more motors and/or actuators (not

shown) associated with the tool flange and each joint. The one or more motors or actuators are responsive to control signals that control the amount of torque provided to the joints by the motors and/or actuators to cause movement, such as rotation, of the tool flange and joints, and thus of arm 101. For example, the motors and/or actuators may be configured and controlled to apply torque to one or more of the joints to control movement of the joints and/or links in order to move the robot tool flange 104 to a particular pose or location in the environment. In some implementations, the motors and/or actuators are connected to the joints and/or the tool flange via one or more gears and the torque applied is based on the gear ratio.

Arm 101 also includes a vision system 90. Arm 101 is not limited to use with this type of vision system or to using these specific types of sensors. Vision system may include one or more visual sensors of the same or different types(s), such as one or more three-dimensional (3D) cameras, one or more two-dimensional (2D) cameras, and/or one or more scanners, such as one or more light detection and ranging (LIDAR) scanner(s). In this regard, a 3D camera is also referred to as an RGBD camera, where R is for red, G is for green, B is for blue, and D is for depth. The 2D or 3D camera may be configured to capture information such as video, still images, or both video and still images. In some implementations, the image can be in form of visual information, depth information and/or a combination thereof, where visual information is indicative of visual properties of the environment such a as color information and grayscale information, and the depth information is indicative of the 3D depth of the environment in the form of point clouds, depth maps, heat maps indicative of depth, or combinations thereof. The information obtained by vision system 90 may be referred to as sensor data and includes, but is not limited, to the images, visual information, depth information, and other information captured by the vision system described herein.

Components of vision system 90 are configured-for example, arranged and/or controllable-to capture sensor data for and/or to detect the presence of objects in the vision system's field-of-view (FOV). This FOV may be based, at least in part, on the orientation of the component(s) of the robotic arm on which the vision system is mounted. In the example of FIG. 1, vision system 90 is mounted on joint 102f and configured to have a FOV having a center at arrow 91, which is parallel to axis 105g. The FOV of the vison system may extend 10°, 20°, 30°, 40°, 50°, 60°, 70°, 80°, 90°, or more equally on both sides of arrow 91 and may increase with distance.

In some implementations, the vision system is static in that its components, such as cameras or sensors, move along with movement of the robotic arm but do not move independently of the robotic arm. For example, the components of the vision system are fixedly mounted to point in one direction, which direction will change based on the position of the component of robotic arm 101 on which those components are mounted. In some implementations, the vision system is dynamic in that its components, such as cameras or sensors, move along with movement of the robotic arm and also move independently of the robotic arm. For example, one or more cameras in vision system 90 may be controlled to move so that its/their field of view centers around arrows 91, 92, 93, and/or others (not shown). To do this, one or more actuators may be controllable to point lenses of corresponding cameras in response control signals from the robot controller described below. In some implementations, the vision system is fixed in the environment of the robotic arm, meaning that the vision system is not on the robotic arm and that its field of view is fixed in relation to the environment and does not move along with movements of the robotic arm. For instance, the vision system can be fixed to monitor a specified area of the environment around the robot base.

In the example of FIG. 1, as previously noted, vision system 90 is mounted on joint 102f, which is a component of robotic arm 101. However, all or part of vision system 90 may be mounted on one or more other components of robotic arm 101. For example, all or part of the vision system may be mounted on tool flange 104. All or part of the vision system may be mounted on a link or other joint in the robotic arm, such as joint 102e or link 111. All or part of the vision system may be distributed across multiple links and/or joints. For example, individual cameras and/or scanners may be mounted to two or more different joints 102f, 102e, and link 111, which differently-mounted cameras and/or scanners together may constitute all or part of the vision system. All or part of the vision system may be external to the robotic arm. For example, individual cameras and/or scanners may be mounted at or on locations in a space or environment containing the robotic arm but not on the robotic arm itself, which cameras and/or scanners together may constitute all or part of the vision system. In some implementations, part of the vision system may be mounted on the robotic arm and part of the vision system may be mounted off of the robotic arm.

Sensor data, including data for images captured by the vision system, is provided to the robot controller described below. The robot controller is configured—for example programmed—to use all or some of this data, such as representing image(s), in the techniques described herein for aligning a component associated with the robotic arm to an object.

As also shown in FIG. 1, system 100 includes robot controller (“controller”) 110 to control operation of arm 101. Controller 110 may be configured to output the control signals described herein to control movement, or restrain movement, of arm 101. Controller 110 may include, for example, one or more microcontrollers, one or more microprocessors, programmable logic such as a field programmable gate array (FPGA), one or more application-specific integrated circuits (ASICs), solid state circuitry, or any appropriate combination of two or more of these types of processing devices.

In some implementations, controller 110 may include local components integrated into, or at a same site as, arm 101. In some implementations, controller 110 may include remote components that are remote in the sense that they are not located on, or at a same site as, arm 101. In some implementations, controller 110 may include computing resources distributed across a centralized or cloud computing service, at least a portion of which is remote from robotic arm 101 and/or at least part of which is local. The local components may receive instructions to control arm 101 from the remote or distributed components and control the motors and/or actuators accordingly.

Controller 110 may be configured to control motion of arm 101 by sending control signals to the motors and/or actuators to control the amount of torque provided by the motors and/or actuators to the joints. The control signals may be based on a dynamic model of arm 101, a direction of gravity, signals from sensors (not shown) connected to or associated with each or some of the joints and/or links in the robotic arm, user-applied force, and/or a computer program stored in a memory 118 of controller 110. In this regard, the torque output of a motor is the amount of rotational force that the motor develops. The dynamic model may be stored in memory 118 of controller 110 or remotely and may define a relationship between forces acting on arm 101 and the velocity, acceleration, or other movement, or lack of movement of arm 101 that result(s) from those forces.

The dynamic model may include a kinematic model of arm 101, knowledge about inertia of arm 101 and other operational parameters influencing the movements of arm 101. The kinematic model may define a relationship between the different parts/components of arm 101 and may include information about arm 101 such as the lengths and/or sizes of the joints and links. The kinematic model may be described by Denavit-Hartenberg parameters or like. The dynamic model may make it possible for controller 110 to determine which torques and/or forces that the motors and/or actuators should provide in order to move joints or other parts of the robotic arm, e.g., at a specified velocity, at a specified, acceleration, or to hold the robot arm in a static pose in the presence or absence of force(s).

Controller 110 may also include, or connect to, an interface device 111. Interface device 111 is configured to enable a user to control and/or to program operations of arm 101 via controller 110. Interface device 111 may be a dedicated device, such as a robotic teach pendent, which is configured to communicate with controller 110 via wired and/or wireless communication protocols. Such an interface device 111 may include a display 112 and a one or more types of input devices 113 such as buttons, sliders, touchpads, joysticks, track balls, gesture recognition devices, keyboards, microphones, and the like. Display 112 may be or include a touch screen acting both as display and input device or user interface. Interface device 111 device may be or include a generic computing device (not shown), such as a smartphone, a tablet, or a personal computer including a laptop computer, configured with appropriate programming to communicate with controller 110. Arm 101 is controllable by controller 110 to operate in different

modes, including a teaching mode. For example, a user may provide instructions to the controller via interface device 111 to cause arm 101 to enter the teaching mode. In the teaching mode, controller 110 controls the amount of torque provided to the joints by the motors and/or actuators to enable arm 101 to maintain a pose in the presence of gravitational force, but also to allow one or more components associated with arm 101, such as one or more links, or more joints, the tool flange, or an end effector, to be moved in response to an applied force. Such movement(s) change(s) the pose of the robotic arm. During or after such movement, controller 110 controls the amount of torque provided to the joints by the motors and/or actuators to enable arm 101 to maintain the changed pose and/or to allow continued movement in response to additional applied force.

In some implementations, the applied force may be manual. For example, a user may grab onto one or more components associated with arm 101, such as one or more links, or more joints, the tool flange, or an end effector, and physically move the component(s) to reposition arm to the changed pose. In some implementations, the applied force may be programmatic. For example, controller 110 may instruct the amount of torque to be provided to the joints by the motors and/or actuators to reposition one or more component(s) into the changed pose. In some implementations, the applied force may be a combination of manual and programmatic.

In the teaching mode, arm 101 is taught various movements, which it may reproduce during subsequent automated operation. For example, in the teaching mode, arm 101, which includes an accessory such as a gripper mounted to tool flange 104, is moved to positions in its environment. Arm 101 is moved into a position that causes the gripper to interact with an object, also referred to as a “primitive”, in the robot's environment. For example, a user may physically/manually grasp part of arm 101 and move that part of arm 101 into a different pose in which the gripper is capable of gripping the object. As noted above, the controller 110 controls the amount of torque provided to the joints by the motors and/or actuators to enable the robotic arm to maintain the different pose and/or to allow continued movement in response to this applied force. The gripper may be controlled by the controller to grasp the object and, thereafter, arm 101, with the gripper holding the object, may be moved into a new pose and position at which the gripper installs the object or deposits the object. The user may physically/manually move the robotic arm into the new pose and position.

Controller 110 records, and stores data representing operational parameters such as an angular position of the output flange, an angular position of a motor shaft of each joint motor, a motor current of each joint motor during movement of the robotic arm, and/or others listed below. This data may be recorded and stored in memory 118 continuously or at small intervals, such as every 0.1 seconds(s), 0.5 s, 1 s, and so forth. Taken together, this data defines the movement of the robotic arm that is taught to the robotic arm during the teaching mode. These movements can later be replicated automatically by executing code on controller 110, thereby enabling the robot to perform the same task automatically without manual intervention.

During user-applied physical movements in particular, it can be challenging to align component(s) associated with the robotic arm with an intended target, such as an object in the environment. Misalignment can adversely affect future operation of the robot. In the example of a gripper, if the gripper is misaligned by as little as single-digital millimeters, the gripper may not be able to grasp the object during automatic operation. Due to the precision required, alignment can be time-consuming for a user to implement. And, even then, the alignment may be prone to error.

The processes described herein may address the foregoing issues by identifying an object in the environment and by controlling at least part of the robotic arm to move into alignment with that object during the teaching mode. By automating at least part of the alignment with the object, the amount of time required during teaching may be reduced, since painstaking manual alignments to objects may no longer be required. Also, automating at least part of the alignment with the object may reduce the occurrence of misalignments.

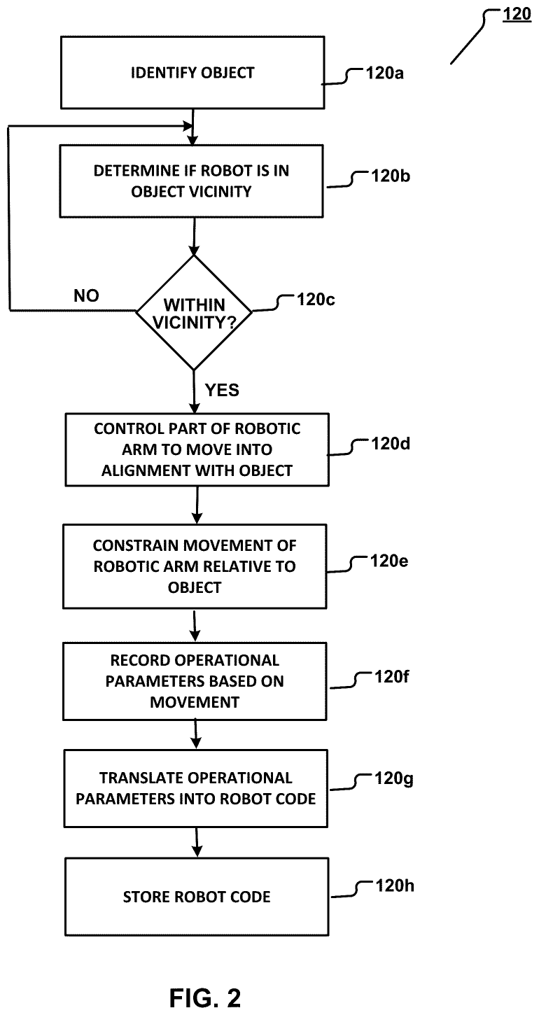

FIG. 2 is a flowchart showing example operations included in an example process 120 of the foregoing type. Process 120 is described with respect to arm 101 and may be performed by controller 110 either alone or in combination with one or more local and/or remote computing systems.

During at least part of process 120, prior to controlling arm 101 to move a component into alignment, controller 110 controls arm 101 to enable manual movement of arm 101 in multiple degrees of freedom. This is done by controlling the amount of torque provided to the joints by the motors and/or actuators. For example, sufficient torque may be applied to overcome gravity, while enabling manual movement of components of arm 101 in multiple—e.g., two, three, four, five, or six—degrees of freedom. In some implementations, this mode of operation is called free-drive mode.

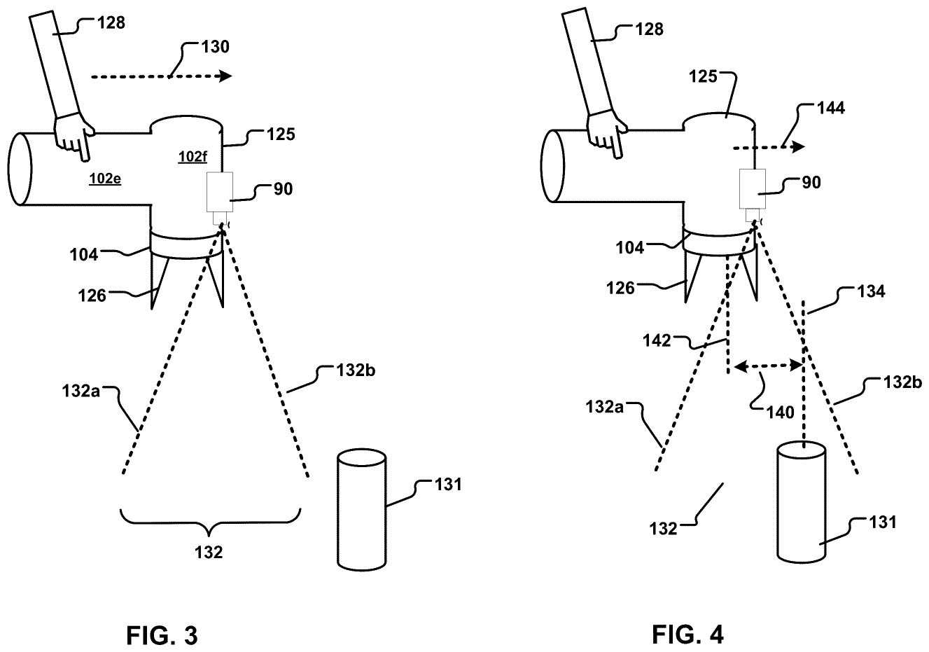

Accordingly, a component associated with arm 101 may be moved manually by a user. The component may be or include any or all of the joints and/or links of FIG. 1, such as joints 102f, 102e, 102d, and/or link 111 for example, and/or an end effector/accessory mounted on arm 101. An example of this movement is depicted graphically in FIG. 3. More specifically, FIG. 3 shows component 125 of arm 101 containing joints 102e, 102f, vision system 90, tool flange 104, and gripper 126 attached to the end effector interface on tool flange 103. The remainder of arm 101 is present, but not shown in FIG. 3 (or FIG. 4, 5, 6, 8, 9, 10, or 11). During the teaching mode, a user 128 manually moves component 125 in the direction of arrow 130 towards object 131, which is to be picked-up by gripper 126. This may be done in the free-drive mode in some implementations. In an example, the object may be a workpiece, a container, a tool, or any other item. Vision system 90 has a FOV 132 depicted graphically by lines 132a, 132b. In FIG. 3 object 131 is outside of FOV 132 of vision system 90 and, therefore, is not detected.

Referring also to FIG. 4, during manual movement in the direction of arrow 130, at least part of object 131 comes within the FOV 132 of vision system 90. When enough of the object is in the FOV, process 120 is able to identify (120a) object 131. For example, process 120 may be able to identify the object if at least 20%, 30%, 40%, 50%, 60%, or more of the object is visible to the vision system. In some implementations, identifying the object may include capturing sensor data, such as one or more images, of an environment using vision system 90 and comparing those image(s) to images of various objects previously stored in memory 118. Image processing techniques may be used to identify the size and shape of the object in the image(s) and to compare those to sizes and shapes of objects stored in memory. When there is sufficient similarity between features of the object in the image(s) and those stored in memory, the object is identified. For example, if an object in the image(s) has at least 60%, 70%, 80%, or more features in common with an object stored in memory, then the object in the image(s) may be deemed to be an instance of the object stored in memory. Similar processing may be performed using sensor data other than images.

Still referring to FIG. 4, identifying (120a) the object may also include identifying an axis 134 along a part of object 131, such as a designated center of object 131. The axis of the object that is used may be based on what the object is. For example, axes for different types of objects may be stored in memory 118 and may be accessed by controller 110 to determine the axis of an identified object. For example, if the object is determined to be a cylinder like object 131 in FIGS. 3 to 6, then controller 110 may read information from memory 118 indicating that the axis is along a longitudinal dimension of the object and through a center of the circular top of the cylinder. Controller 110 may determine the dimensions of the object based on the image(s) of the object, and may calculate the location of the axis of the object based on the read information. In this example, controller 110 identifies the location of axis 134 of object 131 in this manner.

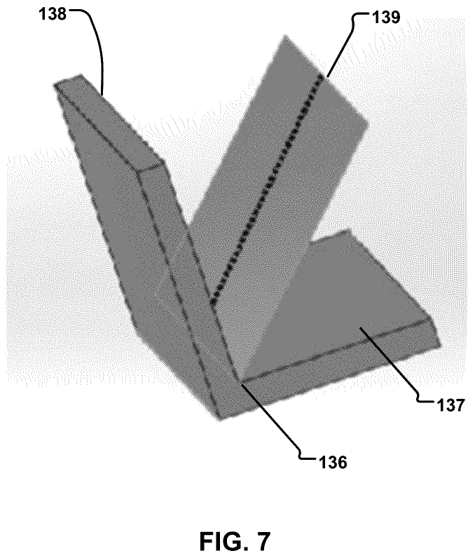

Referring to FIG. 7, in another example, an example object is determined to be a right-angle intersection 136 of two planar surfaces 137, 138 (e.g., an intersection to be welded). Controller 110 may read information from memory 118 indicating where the axis for such an object is located. In this example, the axis 139 is determined to be at 45° relative to each of surfaces 137 and 138. Controller 110 may determine the dimensions of the object based on image(s) of the object, and may calculate the location of axis 139 based on the images(s) and the information obtained from memory 118.

In some robotic systems, sensor data, such as one or more images, of the environment may be received electronically, rather than being captured by vision system 90. In an example like this, the object may be identified using the sensor data in the same manner as described above. In addition, the location of the object in the environment may be identified. For example, controller 110 may store a map of the environment and compare image(s) to the map in order to identify the location of the object within the environment. The axis of the object may be identified as described previously.

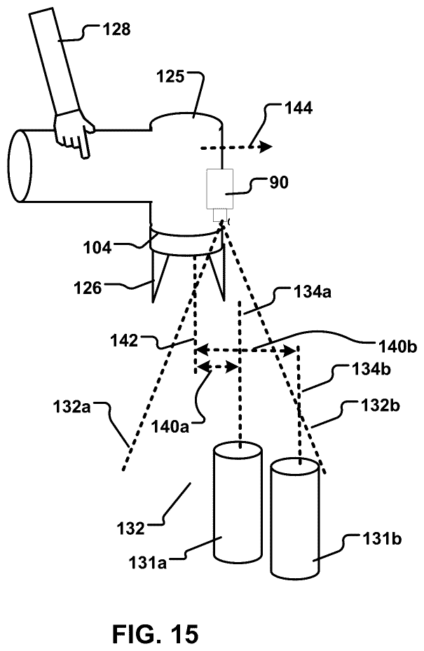

As described below with respect to FIG. 15, if more than one instance of the object is identified in the environment, each instance is a potential candidate for alignment during teaching. In this example, process 120 determines a distance between a component associated with arm 101 and identified instances 131a, 131b of the object. The object that is determined to be closest to the component associated with arm 101 is selected as the one for alignment. Example techniques for calculating the distance between arm 101 and different instances of an object are described below with respect to operation 120b.

Referring back to FIGS. 2 and 3, process 120 includes determining (120b) if a component 125 associated with arm 101, such as joint 102f or gripper 126, is within a predefined vicinity (e.g., distance) of object 131. The magnitude of the predefined vicinity may be set by a user on a teach pendant or by a computer program, may be stored in memory 118, and may be accessible to controller 110. The predefined vicinity may be based on the axis of the object. For example, the predefined vicinity may be defined as a distance between the axis of the object and a specified axis of component 125 of arm 101 that is moved relative to the object. In some implementations, the predefined vicinity may be 50.8 millimeters (mm) (2 inches) or less, 40 mm or less, 30 mm or less, or any other appropriate value.

As explained with respect to FIG. 3, in that example, a user 128 manually moves component 125 of arm 101 in the direction of arrow 130 towards object 131 so that object 131 is within the FOV 132 of vision system 90. The object within the FOV 132 of vision system 90 is shown in FIG. 4. Process 120 identifies object 131 in the manner described above and determines whether component 125 of arm 101 is within a predefined vicinity of object 131. In this example, the predefined vicinity 140 is the distance between axis 134 of object 131 and a predefined axis 142 associated with arm 101. For example, the predefined axis 142 may be the center of tool flange 104 (as in this example) or the center of gripper 126. The predefined axis may be defined to be along a surface of component 125, or along or through any other component, surface, or part of arm 101.

To determine if component 125 of arm 101 is within the predefined vicinity of object 131, process 120 measures the distance between axes 134 and 142 continually, periodically, or sporadically. The distance may be measured based on sensor data, such as image(s), captured by vision system 90 as shown in FIG. 4. For example, controller 110 may know the scale of the images and the FOV 132 of vision system 90. Knowing this information, controller 110 may calculate the real-world distance (as opposed to the distance in the image(s)) between axes 134 and 142. In another example, controller 110 may know the location of the object in the environment based on a map of the environment and determine the location in the environment of component 125 of arm 101 based, for example, on movements of joints in arm 101. Using this information, controller 110 may calculate the real-world distance between axes 134 and 142.

To determine if component 125 of arm 101 is within the predefined vicinity of object 131, controller 110 compares the calculated distance between axes 134 and 142 to the distance that defines the predefined vicinity. If the calculated distance is greater than the distance that defines the predefined vicinity, then component 125 is determined not to be within the predefined vicinity of object 131 (120c). In this case, new values of the calculated distance are determined and compared to the distance that defines the predefined vicinity. During this time, the user can manipulate the arm freely; no extra force will be applied from the arm. This continues during operation of arm 101, e.g., until component 125 is determined to be within the predefined vicinity of object 131. If the calculated distance is less than the distance that defines the predefined vicinity, then component 125 is determined to be within the predefined vicinity of object 131 (120c).

After it is determined (120c) that component 125 of arm 101 is within the predefined vicinity of object 131, processing proceeds to operation 120d. In operation 120d, controller 110 controls arm 101 to move component 125 towards or into alignment with the object. To control arm 101 to move component 125 towards or into alignment with the object, controller 110 controls the amount of torque provided to the joints by the motors and/or actuators. The movement is automatic and does not require manual intervention. Effectively, the torque is provided to the joints by the motors and/or actuators to draw, pull, or move component 125 of robotic arm towards or into alignment using minimal or no additional manual force. For example, drawing, pulling, or moving component 125 towards or into alignment may be implemented absent manual force or with the assistance of manual force.

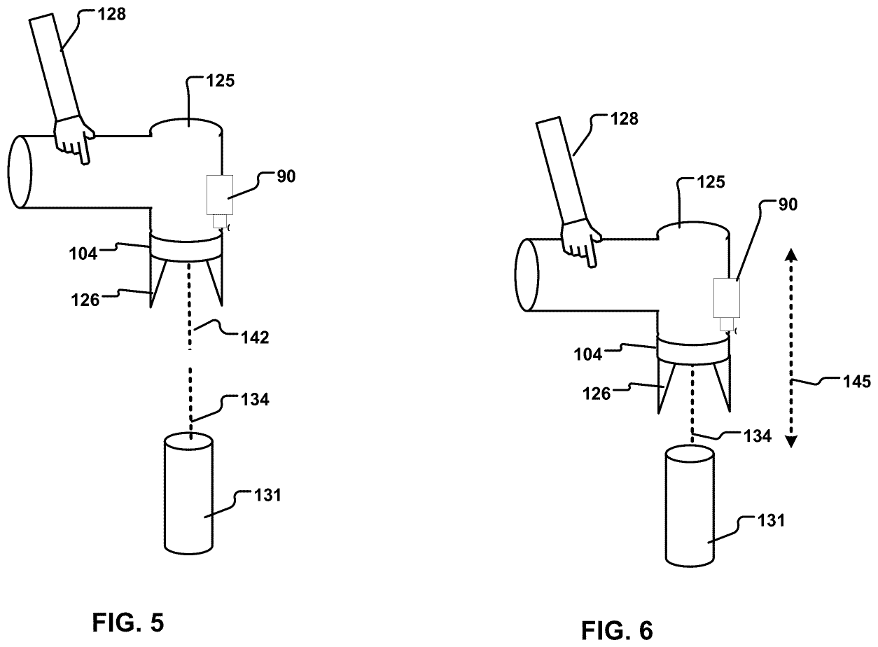

As shown in FIG. 4, the torque is provided to the joints by the motors and/or actuators to draw, pull, or move component 125 in the direction of arrow 144 to arrive at, or close to, the alignment of FIG. 5. In FIG. 4, arrow 144 is from component 125 to indicate that the drawing, pulling, or movement occurs through operation of the motors and/or actuators and not manually (in contrast to FIG. 3 where the movement is manual).

In some implementations, torque is provided to the joints by the motors and/or actuators to generate force to draw, pull, or move component 125 of robotic arm 101 towards alignment with, but not into final alignment with, object 131. In some implementations, the amount of force applied to draw, pull, or move component 125 of robotic arm 101 towards alignment with, but not into final alignment with, object 131, may be set or configured by a user in software that control operation of the robotic arm. For example, a user interface may be generated by the software and output on a display device associated with the robotic arm (e.g., interface device 111), into which a user may provide the requisite amount of force. In an example, the amount of force applied to draw, pull, or move component 125 of robotic arm 101 towards alignment with, but not into final alignment with, object 131 may be 3 Newtons (N), 4 N, 5 N or more. The amount of force that a user may apply manually to overcome the drawing, pulling, or moving may thus be an amount of force that exceeds the amount of force drawing, pulling, or moving component 125 towards alignment with the object.

In some examples, a six degree of freedom force and torque may be applied at the end of the robotic arm. In some implementations, the amount of force is proportional to the distance to the object. For example, as component 125 gets closer to object 131, the amount of force automatically applied to draw, pull, or move component 125 of robotic arm 101 towards alignment with, but not into final alignment with, object 131 may increase proportionally as the distance to the object decreases.

During the time when component 125 of robotic arm 101 is within the predefined vicinity of the object, controller 110 continues to calculate the distance between axes 134 and 142. Upon reaching a predefined threshold distance, which is less than the predefined vicinity, a final alignment process is implemented. For example, the threshold distance may be 10 mm, 5 mm, 4 mm, 3 mm or less, 2 mm or less, 1 mm or less, or any other appropriate distance between axes 134 and 142. The final alignment process may include controlling component 125 to snap component 125 into final alignment with the object. This final alignment may be performed by controlling the motors and/or actuators to provide greater, and more abrupt, torque to the joints than was applied while drawing, pulling or moving component 125 prior to reaching the threshold distance. At the final stage of alignment, the robotic arm is given a move command to the final destination.

In some implementations, the amount of force applied to snap component 124 into final alignment with the object may be set or configured by a user in software that control operation of the robotic arm. For example, a user interface may be generated by the software and output on a display device associated with the robotic arm (e.g., interface device 111), into which a user may provide the requisite amount of force. In an example, the amount of force applied to snap component 124 into final alignment with the object may be 4 N, 5 N, 6 N, 7 N, 8 N, 9 N, 10 N, 11 N, 12 N, 13 N, 14 N, 15 N, or more. The amount of force that a user may apply manually to overcome the snapping action may thus be an amount of force that exceeds the amount of force snapping component 125 into alignment with the object. In some implementations, the snapping action may occur so quickly as to effectively prevent manual intervention to prevent it.

In some implementations, the vision system may confirm the final alignment by capturing sensor data, such as an image, of arm 101 aligned with the object and confirming that the alignment is correct based on positions of the axes of component 125 and object 131.

Following alignment (120d), controller 110 controls the amount of torque provided to the joints by the motors and/or actuators to constrain movement of component 125 relative to the 134 of object 131. For example, the movement of component 125 of arm 101 may be constrained to move in one dimension relative to, or along, axis 134. This is shown in FIG. 6, which depicts component 125 constrained to move vertically along up and down (depicted by arrow 145) along axis 134. In some implementations, the one-dimensional movement may be horizontal or at an oblique angle relative to an object. This movement may be implemented manually to cause gripper 126 to contact object 131 during the teaching mode. The automatic alignment and constrained movement thus reduces the chances of misalignment when component 125 is brought into contact with the object.

In some implementations, the amount of torque that is provided to the joints is sufficient to counteract manual/physical attempts to move component 125 of arm 101 out of alignment with the object or to prevent alignment with the object. For example, in some implementations, an amount of manual force exceeding 4 N, 5 N, 6 N, 7 N, 8 N, 9 N, 10 N, 11 N, 12 N, 13 N, 14 N, 15 N, or more may be used to move component 125 of arm 101 out of alignment with the object.

Referring to FIG. 15, which is a variant of FIG. 4, in some implementations, there may be more than one object 131a, 131b within the FOV 132 of vision system 90. In cases such as this, the distance between predefined axis 142 associated with arm 101 and each of axis 134a of object 131a and axis 134b of object 131b is measured. The distance 140a for object 131a and the distance 140b for object 131b are compared. Whichever distance 140a, 140b is less is identified and the corresponding object is selected as the object to which arm 124 is drawn, pulled, or moved into alignment with. The alignment process then proceeds as described above.

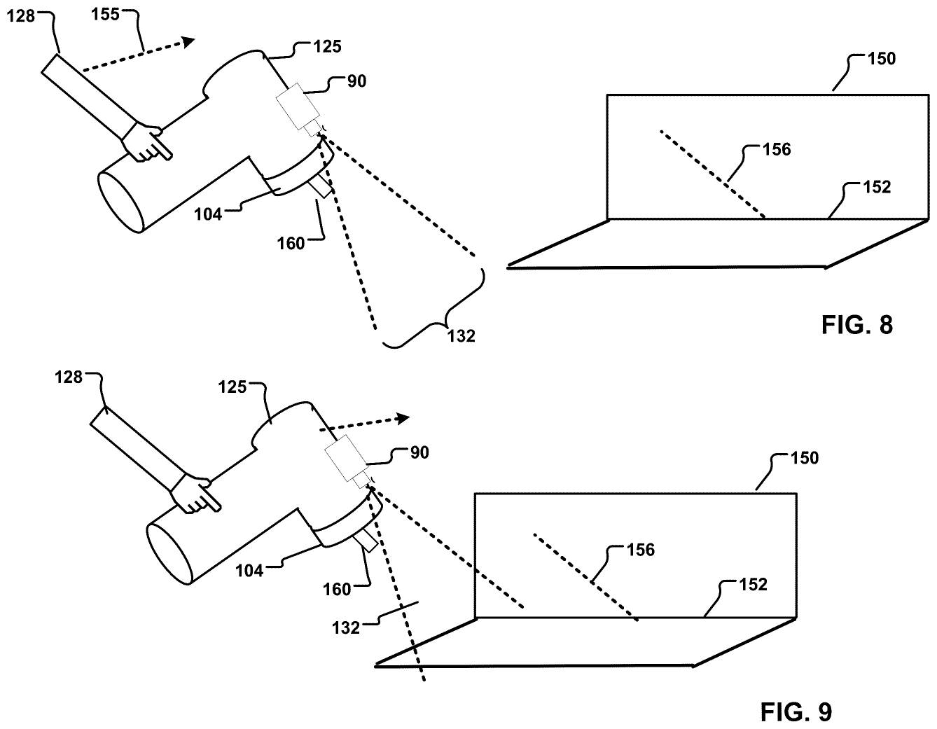

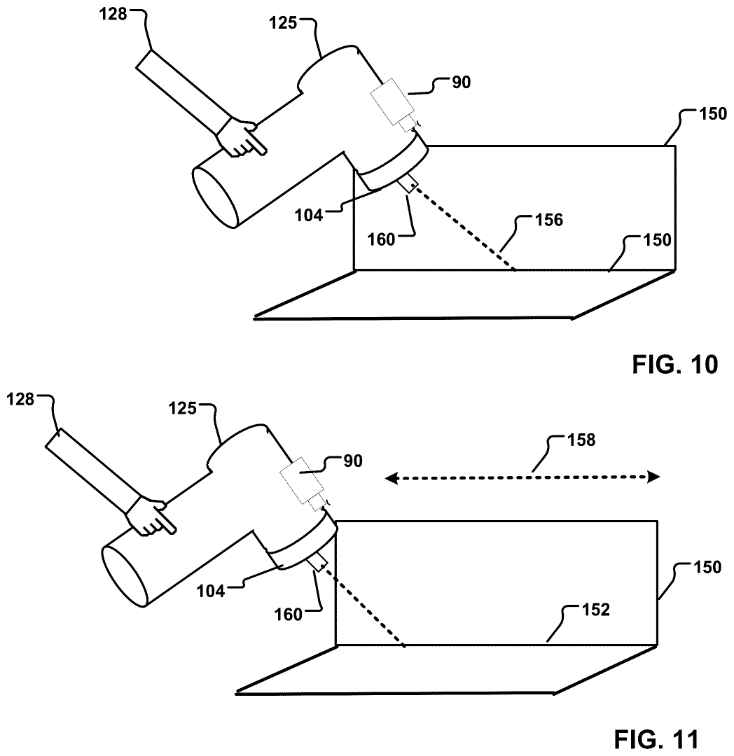

FIGS. 8 to 11 show, graphically, another example of aligning component 125 of a robotic arm to a different object 150. In the example of FIGS. 8 to 11, component 125 of arm 101 is controlled to align to the right-angle intersection 152 of two planes comprising object 150. As shown in FIG. 8, a user 128 manually moves component 125 of arm 101 toward the object in the direction of arrow 155. In FIG. 9, vision system 90 detects object 150. Enough of the object is detected to determine the identity of object 150 based on stored information as described above. Information stored about the object includes the location of axis 156 to which component 125 is to align. When component 125 of arm 101 is within the predefined vicinity of axis 156 of object 150, controller 110 controls the amount of torque provided to the joints by the motors and/or actuators to draw, pull, or move component 125 of arm 101 near or into alignment with axis 156 using minimal or no additional manual force. In some implementations, as described herein, when component 125 is within a threshold distance of axis 156 (e.g., on the order of single-digit millimeters), component 125 may snap into alignment with axis 156. The resulting alignment is shown in FIG. 10. Thereafter, component 125 of arm 101 is constrained to move relative to axis 156 in the directions of arrows 158. In this example, what this means is that component 125 of arm 101 is constrained to move at a 45° angle to the left and to the right of axis 156 along at least the entirety of intersection 152. A use case such as this may be appropriate, e.g., when a welding tool 160 is connected to the end effector interface of tool flange 104 to weld the intersection.

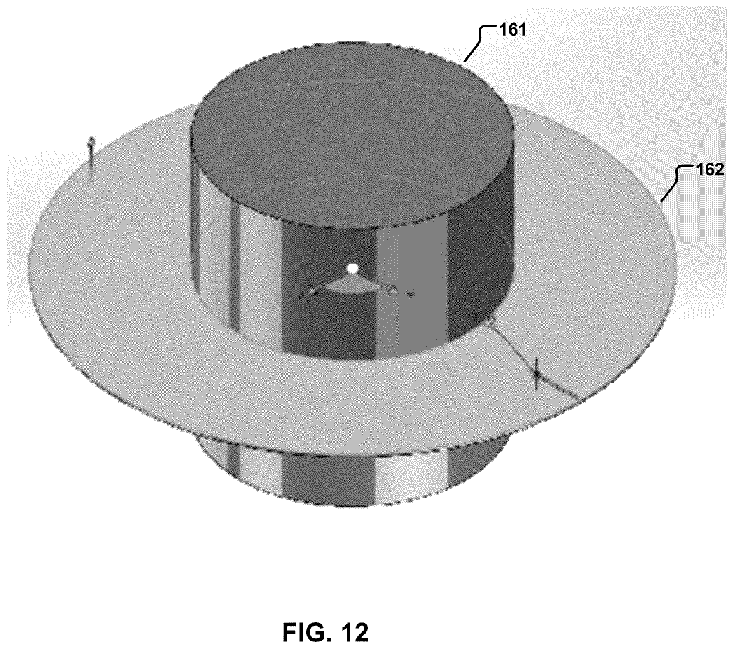

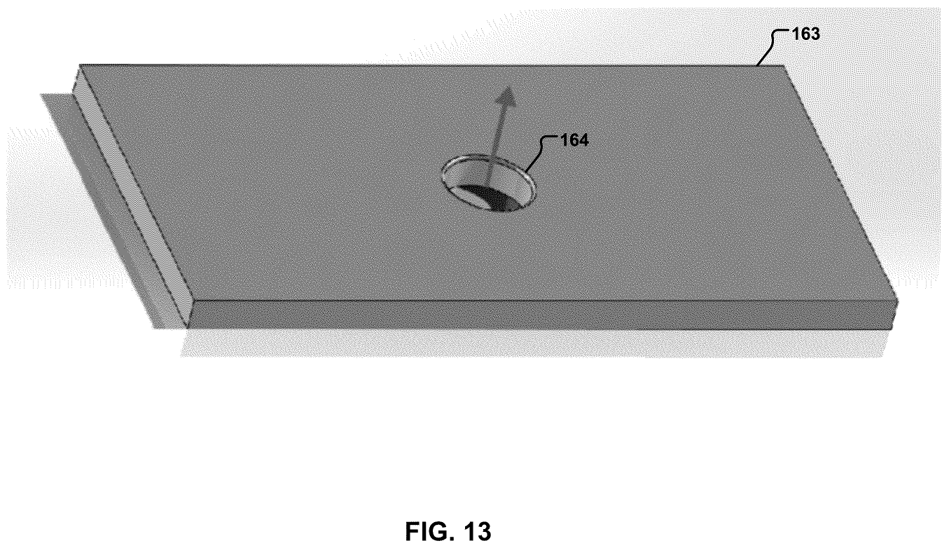

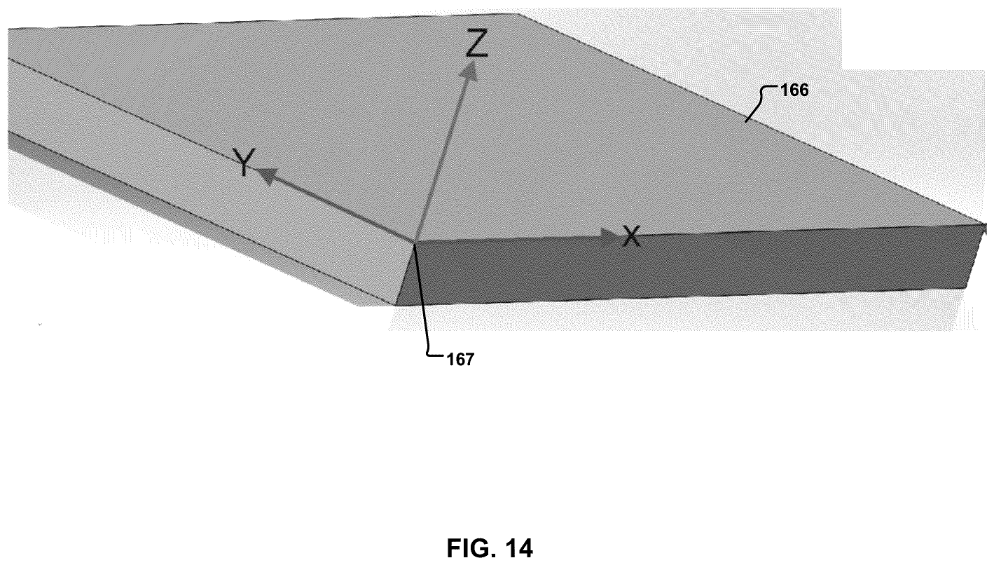

FIGS. 12, 13, and 14 show examples of other objects to which arm 101 may align according to process 120, although it is noted that process 120 may be used to align arm 101 to any appropriate object or part of an object. FIG. 12 shows a cylinder 161 having a flange 162 to which a component of arm 101 may align according to process 120. FIG. 13 shows a plane 163 having a hole 164 therethrough to which a component of arm 101 may align according to process 120. FIG. 14 shows a surface 166 having a corner 167 to which a component of arm 101 may align according to process 120. Generally speaking, arm 101 may align to any type of object having a regular or irregular shape using process 120. in another example (not shown in the figures), arm 101 can be taught to identify a chuck—which is device that securely holds a workpiece in its position during a machining process—of a computer numerical control (CNC) lathe machine and to align a component of arm 101 (such as a gripper) holding the workpiece to the chuck so that the robot can be taught to place the workpiece in the chuck. Referring back to FIG. 2, during the teaching mode, process 120

records (120f) operational parameters associated with arm 101 based on movements made during teaching, including manual movements and automated movements. The operational parameter may be or include any parameters, values and/or states relating to the robot system such as sensor parameters obtained via various sensors on or associated with the robot system. Examples of the sensor parameters include, but are not limited to, angle, position, speed, and/or acceleration of the robot joints; values of force/torque sensors of or on the robot system; images/depth maps obtained by the vision system; environmental sensor parameters such as temperature, humidity or the like; distances measured by distance sensors; and/or positions of devices external to arm 101 such as conveyer positions, speed, and/or acceleration. The operational parameters can also include status parameters of devices associated with, or connected to, the robotic system such as status of end effectors, status of devices external to arm 101, status of safety devices, or the like. The status parameters may also relate to an end effector interface of the robotic system or a tool connected to end effector interface. A force/torque sensor, for example, may be included on the tool flange to measure forces and/or torques applied by the robotic arm. The forces and/or torques may be provide to the robot control system and used to affect-for example, change-operation of the robotic arm. The forces and/or torques many be recorded (120f) as operational parameters.

Additionally, the operational parameters can include parameters generated by a robot program during a recording process such as target torque, positions, speed, and/or acceleration of the robot joints; force/torques that parts of arm 101 or other parts of the of that robotic system experience; and/or values of logic operators such as counters and/or logic values.

The operational parameters can also include external information provided by external systems or central services or other systems; for instance in form of information sent to and from central servers over a network. Such parameters can be obtained via any type of communication ports of the robot system including, but not limited to, digital input/output ports, Ethernet ports, and/or analog ports.

Process 120 translates (120g) all or part of the operational parameters into robot code. Example robot code includes executable instructions that, when executed by controller 110, cause the robot system to perform robot operations, such as imitating and/or replicating the movements performed during teaching that produced the operational parameters, including activating/deactivation end effectors, e.g., opening and/or closing grippers as demonstrated during teaching. The robot code is stored (120h) in memory 118, from which it can be accessed by controller 110. Accordingly, when the robot is no longer in teaching mode, and is instructed to perform a task, the robot code corresponding to that task is retrieved from memory and executed by the robot controller to control operation of the robot to perform the task automatically, e.g., without manual intervention. Controlling operation of the robot may include, for example, controlling torques and/or forces that the motors and/or actuators provide to move joints or other parts of arm 101, e.g., at a specified velocity and/or acceleration, or to hold arm 101 in a particular static pose, among other things in order to perform the task.

Process 120 is described with respect to arm 101 shown in FIG. 1; however, process 120 is not limited to use with robotic arms like those shown in FIG. 1 or even to robotic arms in general. Process 120 is may be used with any part of a robot that is movable in multiple—for example, two, three, four, five or six—degrees of freedom to perform an operation. For example, an automated vehicle, such as a rover, may include an appendage that is controllable according to process 120. In an example, process 120 may be used with an appendage connected to an autonomous vehicle robot of the type that is the subject of U.S. Pat. No. 11,287,824 (issued Mar. 29, 2022), and which is described with respect to FIGS. 1, 2, and 3 thereof. The contents of U.S. Pat. No. 11,287,824 relating to the description of the autonomous vehicle are incorporated herein by reference. In another example, process 120 may be used with an appendage connected to an autonomous vehicle robot of the type that is the subject of U.S. Patent Publication No. 2021/0349468 (published Nov. 11, 2021), and which is described with respect to FIGS. 1, 2, and 3 thereof. The contents of U.S. Patent Publication No. 2021/0349468 relating to the description of the autonomous vehicle are incorporated herein by reference.

The example robots, systems, and components thereof, described herein can be controlled, at least in part, using one or more computer program products, e.g., one or more computer program tangibly embodied in one or more information carriers, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing at least part of the robots, systems, and components thereof can be performed by one or more programmable processors executing one or more computer programs to perform the functions described herein. At least part of the robots, systems, and components thereof can be implemented using special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, e.g., magnetic, magneto-optical disks, or optical disks. Machine-readable storage media suitable for embodying computer program instructions and data include all forms of non-volatile storage area, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks.

In the description and claims provided herein, the adjectives “first”, “second”, “third”, and the like do not designate priority or order unless context indicates otherwise. Instead, these adjectives may be used solely to differentiate the nouns that they modify.

Any mechanical or electrical connection herein may include a direct physical connection or an indirect connection that includes intervening components unless context indicates otherwise.

Elements of different implementations described herein may be combined to form other implementations not specifically set forth above. Elements may be left out of the structures described herein without adversely affecting their operation. Furthermore, various separate elements may be combined into one or more individual elements to perform the functions described herein.

What is claimed is:

1. A robotic system comprising:
a robotic arm configured to move in multiple degrees of freedom; and
a control system comprising one or more processing devices, the one or more processing devices being programmed to perform operations comprising:
identifying an object in the environment accessible to the robotic arm based on sensor data indicative of one of more properties of the environment;
determining that a component associated with the robotic arm is within a predefined distance of the object; and
controlling the robotic arm to move the component toward or into alignment with the object in response to the component being within the predefined distance of the object.

2. The robotic system of claim 1, wherein identifying the object comprises identifying an axis of the object;
wherein the predefined distance is measured relative to the axis of the object; and
wherein controlling the robotic arm to move the component toward or into alignment comprises controlling the robotic arm to move the component toward or into alignment with the axis.

3. The robotic system of claim 2, wherein the axis is along a center of the object.

4. The robotic system of claim 2, wherein the axis is along a part of the object.

5. The robotic system of claim 2, wherein the operations comprise:
following alignment of the component with the axis, constraining movement of at least part of the robotic arm to be along the axis.

6. The robotic system of claim 2, wherein the operations comprise:
following alignment of the component with the axis, constraining movement of at least part of the robotic arm relative to the axis.

7. The robotic system of claim 2, wherein the operations comprise:
following controlling the robotic arm to move the component toward or into alignment with the object; enabling manual movement of at least part of the robotic arm along the axis to allow the robotic arm to interact with the object;
recording movements of the robotic arm interacting with the object;
translating the movements into robot code; and
storing the robot code in memory on the control system.

8. The robotic system of claim 1, wherein the operations comprise:
recording operational parameters of the robotic system;
translating the operational parameters into robot code; and
storing the robot code in memory on the control system.

9. The robotic system of claim 8, wherein the operational parameters relate to one or more of the following: sensor data of said robotic system, input/output ports in the robotic system, or an end effector or tool of the robotic system.

10. The robotic system of claim 1, wherein the operations comprise, prior to controlling the robotic arm to move the component toward or into alignment, controlling the robotic arm to enable manual movement of the robotic arm in multiple degrees of freedom; and
wherein controlling the robotic arm to move the component toward or into alignment is performed automatically absent manual intervention.

11. The robotic system of claim 1, wherein the operations comprise, prior to controlling the robotic arm to move the component toward or into alignment, controlling the robotic arm to enable manual movement of the robotic arm in multiple degrees of freedom; and
wherein controlling the robotic arm to move the component toward or into alignment is performed in combination with manual movement of the robotic arm.

12. The robotic system of claim 1, wherein the component comprises a tool or end effector connected to the robotic arm.

13. The robotic system of claim 1, wherein the component comprises a part of the robotic arm.

14. The robotic system of claim 1, further comprising:
a vision system associated with the robotic arm to capture the sensor data.

15. The robotic system of claim 1, wherein the vision system comprises one or more cameras mounted to the robotic arm.

16. The robotic system of claim 1, wherein the operations comprise:
receiving the sensor data electronically.

17. The robotic system of claim 1, wherein the operations comprise:
enabling the robotic arm to be moved out of the predefined distance during alignment in response to a predetermined amount of manual force.

18. The robotic system of claim 1, wherein the environment contains multiple objects, each of the multiple objects being a candidate for alignment with the component, and each of the multiple objects being at a different distance from the component.

19. The robotic system of claim 18, wherein the object to which the component is configured to align is a closest one of the multiple objects to the component.

20. A method of controlling a robotic arm, the method comprising:
obtaining sensor data indicative of one of more properties of an environment accessible to the robotic arm;
identifying an object in the environment based on the sensor data;
determining that a component associated with the robotic arm is within a predefined distance of the object; and
controlling the robotic arm to move the component toward or into alignment with the object in response to the component being within the predefined distance of the object.

21. The method of claim 20, wherein identifying the object comprises identifying an axis of the object;
wherein the predefined distance is measured relative to the axis of the object; and
wherein controlling the robotic arm to move the component toward or into alignment comprises controlling the robotic arm to move the component toward or into alignment with the axis.

22. The method of claim 21, wherein the axis is along a center of the object.

23. The method of claim 21, wherein the axis is along a part of the object.

24. The method of claim 21, further comprising:
following alignment of the component with the axis, constraining movement of at least part of the robotic arm to be along the axis.

25. The method of claim 21, further comprising:
following alignment of the component with the axis, constraining movement of at least part of the robotic arm relative to the axis.

26. The method of claim 21, further comprising:
following controlling the robotic arm to move the component toward or into alignment with the object; enabling manual movement of at least part of the robotic along the axis to allow the robotic arm to interact with the object;
recording movements of the robotic arm interacting with the object;
translating the movements into robot code; and
storing the robot code in memory on the control system.

27. The method of claim 20, further comprising:
recording operational parameters of the robotic system;
translating the operational parameters into robot code; and
storing the robot code in memory on the control system.

28. The method of claim 26, wherein the operational parameters relate to one or more of the following: input/output ports in the robotic system or an end effector or tool connected to the robotic arm.

29. The method of claim 20, further comprising:
prior to controlling the robotic arm to move the component toward or into alignment, controlling the robotic arm to enable manual movement of the robotic arm in multiple degrees of freedom; and
wherein controlling the robotic arm to move the component toward or into alignment is performed automatically absent manual intervention.

30. The method of claim 29, further comprising:
prior to controlling the robotic arm to move the component toward or into alignment, controlling the robotic arm to enable manual movement of the robotic arm in multiple degrees of freedom; and
wherein controlling the robotic arm to move the component toward or into alignment is performed in combination with manual movement of the robotic arm.

31. The robotic of claim 20, wherein the component comprises a tool connected to the robotic arm.

32. The method of claim 20, wherein the component comprises a part of the robotic arm.

33. The method of claim 20, wherein the one or more images are obtained electronically.

34. The method of claim 20, wherein the one or more images are obtained from one or more cameras connected to the robotic arm.

35. The method of claim 20, further comprising:
enabling the robotic arm to be moved out of the predefined distance during alignment in response to a predetermined amount of manual force.

36. The method of claim 20, wherein the environment contains multiple objects, each of the multiple objects being a candidate for alignment with the component, and each of the multiple objects being at a different distance from the component.

37. The method of claim 20, wherein the object to which the component is configured to align is a closest one of the multiple objects to the component.

38. One or more non-transitory machine-readable storage devices storing instructions that are executable by one or more processing devices to control a robotic arm, the instructions being executable to perform operations comprising:
obtaining sensor data indicative of an environment accessible to the robotic arm;
identifying an object in the environment based on the sensor data;
determining that a component associated with the robotic arm is within a predefined distance of the object; and
controlling the robotic arm to move the component toward or into alignment with the object in response to the component being within the predefined distance of the object.

39. The robotic system of claim 1, wherein determining that the component associated with the robotic arm is within the predefined distance of the object comprises determining that the component of the robotic arm is within a first distance from the object;
wherein controlling the robotic arm to move the component toward alignment with the object is performed in response to the component of the robotic arm being within the first distance from the object;
wherein determining that the component associated with the robotic arm is within the predefined distance of the object comprises determining that the component of the robotic arm is within a second distance from the object, the second distance being less than the first distance; and
wherein controlling the robotic arm to move the component into alignment with the object is performed in response to the component of the robotic arm being within the second distance from the object and is performed with greater force than moving the component toward alignment.
